(19) United States
(12) Patent Application Publication
(10) Pub. No.: US 2025/0040737 A1
(43) Pub. Date: Feb. 6, 2025

(54) A DRINKING STRAW, A DEVICE FOR FORMING A DRINKING STRAW, A METHOD FOR FORMING A DRINKING STRAW AND A LIQUID FOOD PACKAGE

(71) Applicant: Tetra Laval Holdings & Finance S.A., Pully (CH)

(72) Inventors: Anders JOHANSSON, Lund (SE); Staffan LINDÉN, Lund (SE); Andreas ÅBERG, Lund (SE); Petra BÅÅTH, Lund (SE)

(73) Assignee: Tetra Laval Holdings & Finance S.A., Pully (CH)

(21) Appl. No.: 18/836,125

(22) PCT Filed: Feb. 1, 2023
(86) PCT No.: PCT/EP2023/052466

§ 371 Date: Aug. 6, 2024

(30) Foreign Application Priority Data
Feb. 15, 2022 (EP) 22156763.9

(51) Int. Cl. A47G 21/18; B31D 5/00

(52) U.S. Cl. CPC A47G 21/18; B31D 5/0086

(57) ABSTRACT

A drinking straw is disclosed. The drinking straw comprising at least one elongated tubular main body portion; the elongated tubular main body portion comprising a pinched end portion, wherein the pinched end portion defines opposite compressed edges of the elongated tubular main body portion, and wherein the pinched end portion is cut with an oblique angle in relation to an longitudinal extension of the at least one elongated tubular main body portion and extending between the opposite compressed edges, thereby defining a cut tip, wherein an outermost tip of the cut tip coincides with one of the compressed edges.

### TECHNICAL FIELD

The invention generally relates to a drinking straw. More particularly, it is related to a drinking straw comprising at least one elongated tubular main body portion having a pinched end portion. The invention also relates to a device for forming a drinking straw. The invention also relates to a method for forming a drinking straw. The invention also relates to a liquid food package comprising a drinking straw.

### BACKGROUND ART

Drinking straws to be used for a liquid food package holding a drinkable food product are well-known in the art. Typically, a drinking straw being designed to be able to penetrate a membrane of a packaging material of the liquid food package such that the drinkable food product may be drunk directly from the liquid food package by using the drinking straw. A liquid food package typically exhibit a dedicated weakened area where a dinking straw is to be inserted into the package. Such weakened area typically include an opening covered with a liquid proof membrane. The membrane, typically being of packaging material may have a layer of plastic polymer, aluminum, paper, or laminated layers of any combination of plastic polymer, aluminum and paper layers. The drinking straw should be able to penetrate the membrane. Today, it is also well-known to use drinking straws made of paper-based material in order to produce environmentally friendly drinking straws.

Even though drinking straws to be used with liquid food packages have been used by customer for decades, there is room for improvements. For instance, a challenge with today's drinking straws made of paper-based material is that they may sometimes not be able to penetrate the membrane of the package at hand. The drinking straw may sometimes not be able to penetrate the membrane at all or may be able to penetrate the membrane but at the same time become damaged.

For these reasons, there is a demand for a drinking straw that is capable of penetrating the membrane of packaging material with a reduce risk of damaging the drinking straw.

### SUMMARY

It is an object of the disclosure to provide a drinking straw that is capable of penetrating a membrane of a packaging material.

Another object is to provide such a drinking straw that is capable of penetrating a membrane of a packaging material without the risk, or at least with a reduced risk, of damaging the drinking straw.

Another object is to provide such a drinking straw that is capable of penetrating a dedicated membrane of a material differing from a major packaging material of a liquid food package without the risk, or at least with a reduced risk, of damaging the drinking straw.

Another object is to provide a drinking straw which is environmentally friendly.

Another object is to provide a cost-efficient drinking straw.

Another object is to provide a device for forming a drinking straw of the above kind.

Another object is to provide a method for forming a drinking straw of the above kind.

According to a first aspect, it is provided a drinking straw comprising at least one elongated tubular main body portion; the elongated tubular main body portion comprising a pinched end portion, wherein the pinched end portion defines opposite compressed edges of the elongated tubular main body portion, and wherein the pinched end portion is cut with an oblique angle in relation to an longitudinal extension of the at least one elongated tubular main body portion and extending between the opposite compressed edges, thereby defining a cut tip, wherein an outermost tip of the cut tip coincides with one of the compressed edges.

The drinking straw may have a longitudinal symmetry plane. The opposite compressed edges may be both arranged on the longitudinal symmetry plane. As a result, the outermost tip of the cut tip is also on the longitudinal symmetry plane. This further provides for an increased strength of the compressed edges, the cut tip and especially for the outermost tip which is for penetrating the membrane.

The drinking straw may be a straight drinking straw, a telescopic drinking straw, a U-shaped drinking straw, a sensory drinking straw, a Z-shaped drinking straw etc. Thus, it should be understood that the drinking straw may take any shape known in the art.

The pinched end portion may also be referred to as a compressed end portion, a squeezed end portion, a clamped end portion etc. Thus, it should be understood that the end portion has been pinched, compressed, squeezed or clamped thereby providing a plastic deformation of the elongated tubular main body portion to form the pinched end portion. The pinched end portion may be pinched in a first direction thereby forming the pinched end portion which defines the opposite compressed edges. Preferably, the first direction being transverse to a longitudinal extension of the at least one elongated tubular main body portion. Portions of the elongated tubular main body portion which is not forming the pinched end portion, e.g. un-pinched portions, are typically of a circular shape. However, other shapes apart from a circular shape may be used to advantage. In other words, the drinking straw may exhibit other cross-sectional shapes than a circular shape.

By having an outermost tip of the cut tip coinciding with one of the compressed edges, a sharper and stiffer cut tip is achieved. Further by having an outermost tip of the cut tip coinciding with one of the compressed edges, an improved sharpness and stiffness of the outermost tip of the drinking straw which is the part of the drinking straw which is for penetrating the membrane of packaging material is achieved. The reason for this is at least two-fold. Firstly, the fact that the pinched end portion defines opposite compressed edges results in an improved stiffness where the respective compressed edges act as stiffening ribs. Secondly, the fact that the drinking straw includes a pinched end portion defining opposite compressed edges results in that a sharper tip is formed when the pinched end portion is cut at an oblique angle such that an outermost tip of the cut tip coincides with one of the compressed edges.

By having the improved sharpness and stiffness of the tip, the drinking straw is able to penetrate the membrane without the risk, or at least with a reduced risk, of damaging the drinking straw. The membrane may be made of a material differing from a major material of the package. The membrane may be made of the same material as the package itself. The improved shape of the tip concentrates the penetration forces and provides more robustness against user handling. By being able to concentrate the penetration forces, a more distinct opening may be provided which in turn provides for an easier opening without the risk, or at least with a reduced risk, of damaging the drinking straw.

This is especially advantageous when the membrane is made of packaging material without aluminum as a gas and/or light barrier such as a polymer material or a paper-based material, for instance metalized polymer film or metalized paper-based layer. Polymer materials or paper-based materials tends to be somewhat though and hence not always easy to penetrate. However, a packaging material made of aluminum, or made of a combination of aluminum and one or more other materials, is relatively easier to penetrate than a membrane without any aluminum due to the somewhat brittle nature of aluminum.

Thus, the disclosed drinking straw provides an improved drinking straw compared to conventional drinking straws.

The pinched end portion may be cut with an oblique angle of 30-70 degrees, preferably 40-60 degrees, more preferably 50 degrees.

In this context, the pinched end portion is cut with the oblique angle transverse to the longitudinal extension of the at least one elongated tubular main body portion. The oblique angle as discussed above may also be referred to as a cut angle. This is advantageous in that it allows for forming the sharp cut tip such that the drinking straw is able to penetrate the membrane in a desired way. If the oblique angle or cut angle is too small, the cut tip may not be sharp enough. If the oblique angle or cut angle is too large, the cut tip may be too sharp but may be less stiff thereby having an increased risk of damaging the drinking straw when penetrating the membrane. Thus, the cut angle together with the plastic deformation of the compressed edges may form synergistically an improved cut tip which is able to penetrate the membrane in the desired way.

A bending radius of the associated compressed edge at the outermost tip may be 2-5%, preferably 3.5%, of a diameter of an un-pinched portion of the elongated tubular main body portion.

In this context, the bending radius is the outer radius of the outermost tip. The bending radius is formed by forming the pinched end portion with a predetermined compression force. This is advantageous in that it allows for forming the sharp cut tip such that the drinking straw is able to penetrate the membrane in a desired way.

The pinched end portion may have an increased degree of compression towards the outermost tip.

This is advantageous in that it allows for forming the pinched end portion which is not oval, but, takes any other suitable form depending on how it is pinched, e.g. owing form a shape of a pinching tool. Typically, the pinched end portion may take the general form of a diamond. When the pinched end portion takes the form of a diamond, each of the compressed edges defines a respective crease line. The compressed edges may have both arranged on the longitudinal symmetry plane previously stated. As a result, the outermost tip of the cut tip is also on the longitudinal symmetry plane. The respective crease line acts as stiffening ribs and provides for an increased strength of the compressed edges, the cut tip and especially for the outermost tip which is for penetrating the membrane. Additionally, as part of the shape of diamond, the straw may have two more crease lines facing each other as arranged on opposite sides of the longitudinal symmetry plane. The two more crease lines act also as stiffening ribs and provides increased strength to the straw.

The pinched end portion is typically formed by plastic deformation of the drinking straw such that the pinched end portion remains even after the compression forces have been removed.

The pinched end portion may have an increased degree of compression towards the outermost tip seen along a longitudinal direction as well. This is advantageous in that it allows for forming the sharpness of the outermost tip such that the drinking straw structure is able to penetrate the membrane. This is further advantageous in that it provides for a smooth transition between the un-pinched portion of the elongated tubular main body portion and the pinched end portion. That may also help the drinking straw to penetrate (or slide) in the package smoothly through the membrane after it is ruptured by the outermost tip.

The pinched end portion may have a longitudinal extension from the outermost tip which is 50-400%, preferably 150-300%, more preferably 250-300% of the diameter of the un-pinched portion of the elongated tubular main body portion.

This is advantageous in that it allows for forming a stronger outermost tip compared to if only the outermost tip would have been compressed. It also allows for that a flow of a liquid through the drinking straw is less affected as compared to if the complete drinking straw were to be pinched.

The drinking straw may be made of paper-based material. Preferably, the straw is made from a paper-based material. Paper-based material is environmentally friendly and can be recycled in a simple manner. It should be noted that the straw may be made of other materials.

According to a second aspect it is provided a device for forming a drinking straw from an elongated tubular body, the device comprising a mold configured to receive and pinch a portion of the elongated tubular body, wherein the mold is configured to pinch the portion thereby forming opposite compressed edges of the elongated tubular body, and a cutting blade configured to cut the portion with an oblique angle in relation to a longitudinal extension of the elongated tubular body between the opposite compressed edges while forming at least one cut tip at the portion of the elongated tubular body, thereby forming the drinking straw, wherein the drinking straw has at least one elongated tubular main body portion and a pinched end portion, wherein the pinched end portion has a cut tip, wherein an outermost tip of the cut tip coincides with one of the compressed edges.

The drinking straw may have a longitudinal symmetry plane. The opposite compressed edges may be both formed on the longitudinal symmetry plane. As a result, the outermost tip of the cut tip is also formed on the longitudinal symmetry plane. This further provides for an increased strength of the compressed edges, the cut tip and especially for the outermost tip which is for penetrating the membrane.

This is advantageous in that it allows for the elongated tubular body to have any longitudinal extension, as long as the longitudinal extension is not shorter than a desired length of the drinking straw, for forming the drinking straw. Preferably, the tubular main body may have a longitudinal extension being substantially equal to a length of a drinking straw. The portion which is configured to be pinched and cut is then preferably arranged at an end of the elongated tubular body. This is advantageous in that it allows for as little material a possible to be cut from the elongated tubular body when forming the drinking straw. Thus, a small amount of waste material is provided.

This is further advantageous in that it allows for forming the drinking straw as discussed above in an easy and efficient way.

The drinking straw may be obtained by using other tools than the mold and the cutting blade. The portion may be pushed through a preformed channel and thereafter be cut. The portion may be punched towards the cutting blade. The portion may be cut by a guillotine having angled knives or an angled knife.

The elongated tubular body may have a longitudinal extension being equal to a length of two drinking straws and wherein the mold may be configured to receive and pinch a central portion of the elongated tubular body and the cutting blade may be configured to cut the central portion of the elongated tubular body, thereby forming two drinking straws, wherein each drinking straw has at least one elongated tubular main body portion and a pinched end portion, wherein the pinched end portion has a cut tip, wherein an outermost tip of the cut tip coincides with one of the compressed edges.

The elongated tubular body may have a longitudinal extension being substantially equal to a length of two drinking straws.

It should be noted that the portion as discussed above may coincide with the central portion.

This is advantageous in that it allows for forming two drinking straws at the time. This facilitates the provision of an efficient production of drinking straws in which no material waste, or at least a reduced amount of material waste, is generated.

The mold may comprise a plurality of lower mold sections, each mold section being arranged about a periphery of a roller and being configured to feed the elongated tubular body to a pinching and cutting position when the roller being rotated about a main axis, and an upper mold section being configured to be moved in a transverse direction (in other words, radial direction of the roller) towards one of the plurality of lower mold sections being arranged in the pinching and cutting position, wherein, when the upper mold section is moved towards the one of the plurality of lower mold sections, the upper mold section and the lower mold section pinches the portion of the elongated tubular body.

The plurality of lower mold sections is advantageous in that it allows for transporting the elongated tubular body to the pinching and cutting position in an easy and efficient way as well as being a part of the pinching. It should be noted that the plurality of mold sections may be configured to transport the drinking straw from the pinching and cutting position as well. This is further advantageous in that it allows for an easy and efficient pinching step of the elongated tubular body.

The upper mold section is advantageous in that is allows for being arranged with the cutting blade such that an efficient pinching and cutting mechanism is achieved.

The combination of the plurality of lower mold sections and the upper mold section is advantageous in that it allows for an efficient pinching mechanism for forming the pinched end portion of the elongated tubular body.

The upper mold section and each of the plurality of lower mold sections may comprise a respective cutting blade receiving notch configured to receive the cutting blade while cutting of the portion of the elongated tubular body.

This is advantageous in that it allows for the cutting blade to cut the portion of the elongated tubular body with no impact, or at least a reduced amount of impact, on the upper and lower mold sections. In practice, the respective cutting blade receiving notches are configured to house the cutting blade during cutting such that no physical contact between the cutting blade and the mold occurs. In this way the cutting blade will not become blunt from physical contact with the mold.

The cutting blade may be a rotating circular cutting blade. This is advantageous in that it allows for an easy and efficient cutting mechanism for cutting the portion of the elongated tubular body. Further, a rotating cutting blade allows for a smooth cut with a reduced surface roughness as compared to a static cutting blade.

Additionally, as part of a shape of diamond, the straw may be formed having two more crease lines facing each other as arranged on opposite sides of the longitudinal symmetry plane. The two more crease lines act also as stiffening ribs and provides increased strength to the straw.

According to a third aspect it is provided a method for forming a drinking straw form an elongated tubular body, the method comprising pinching a portion of the elongated tubular body thereby forming opposite compressed edges; and cutting the pinched portion at an oblique angle in relation to the longitudinal extension of the elongated tubular body between the opposite compressed edges, thereby forming the drinking straw, wherein the drinking straw has at least one elongated tubular main body portion and a pinched end portion, wherein the pinched end portion has a cut tip, wherein an outermost tip of the cut tip coincides with one of the compressed edges.

The drinking straw may have a longitudinal symmetry plane. The opposite compressed edges may be both formed on the longitudinal symmetry plane. As a result, the outermost tip of the cut tip is also formed on the longitudinal symmetry plane. This further provides for an increased strength of the compressed edges, the cut tip and especially for the outermost tip which is for penetrating the membrane.

The step of cutting the pinched portion may comprise cutting the pinched portion at a central portion of the elongated tubular body, thereby forming two corresponding drinking straws, wherein each drinking straw has at least one elongated tubular main body portion and a pinched end portion, wherein the pinched end portion has a cut tip, wherein an outermost tip of the cut tip coincides with one of the compressed edges.

The step of pinching the portion of the elongated tubular body may provide an increased degree of compression towards the outermost tip.

Additionally, as part of a shape of diamond, the straw may be formed having two more crease lines facing each other as arranged on opposite sides of the longitudinal symmetry plane. The two more crease lines act also as stiffening ribs and provides increased strength to the straw.

According to a fourth aspect it is provided a liquid food package for holding a liquid food product, the liquid food package comprising a main body for holding the liquid food product, and a drinking straw according to any one of claims 1-6 being attached to an outside surface of the main body.

Effects, advantages and features of the second, third and fourth aspects are largely analogous to those described above in connection with the first aspect. Consequently, said effect, advantages and features will not be repeated in order to avoid undue repetition.

Still other objectives, features, aspects and advantages will appear from the following detailed description as well as from the drawings.

### BRIEF DESCRIPTION OF THE DRAWINGS

Embodiments will now be described, by way of example, with reference to the accompanying schematic drawings, in which

FIG. 1 is a perspective view of a liquid food package comprising a drinking straw.

FIG. 2a illustrates a perspective view of a drinking straw.

FIG. 2b illustrates a pinched end portion of the drinking straw as illustrated in FIG. 2a.

FIG. 3 illustrates a device for forming the drinking straw of FIGS. 2a and 2b.

FIG. 4 illustrates a variant of the device as illustrated in FIG. 3.

FIG. 5 illustrates a roller comprising a plurality of lower mold sections of the device.

FIG. 6 illustrates an upper mold section of the device.

FIGS. 7a-7d illustrates steps of forming the drinking straw as illustrated in FIGS. 2a-2b.

FIG. 8 is a flowchart illustrating steps of a method for forming a drinking straw.

### DETAILED DESCRIPTION

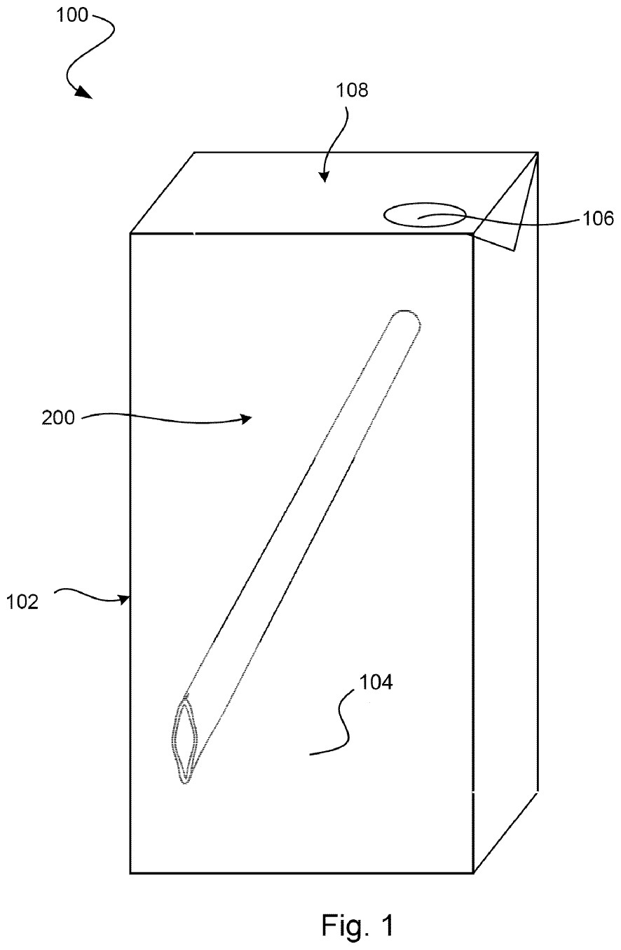

With reference to FIG. 1, a liquid food package 100 is illustrated by way of example. The liquid food package 100 is for holding a drinkable food product or a liquid food product. The liquid food package 100 is formed as a rectangular or cuboid bottle formed by a carton-based main body 102. The carton-based main body 102 is preferably made of carton-based laminate. It should be noted that the liquid food package 100 may be formed in any suitable way, from any suitable material, as long as it is configured to hold the drinkable food product, preferably in an easy and safe way.

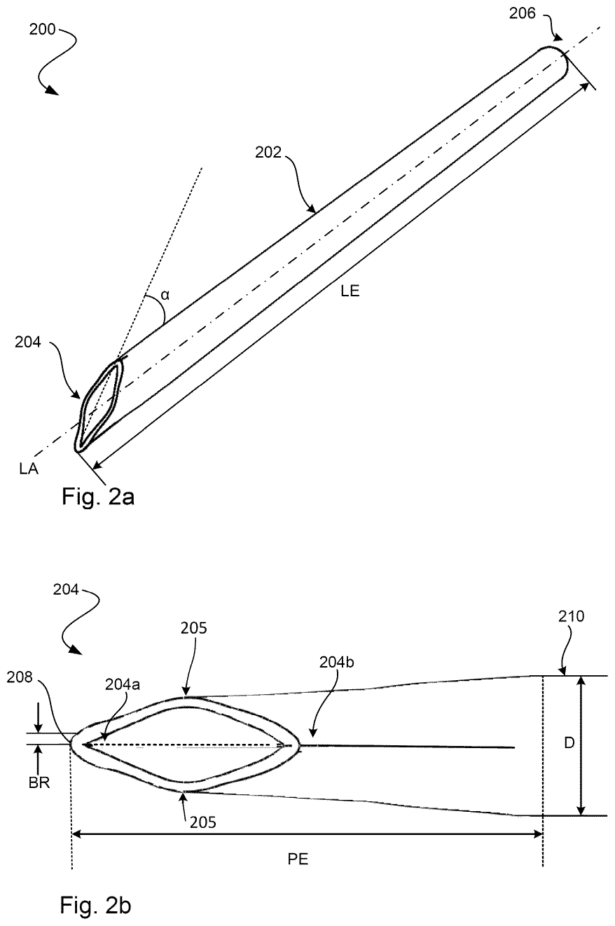

The liquid food package 100 further comprises a drinking straw 200 which is further illustrated and discussed in FIGS. 2a-2b. The drinking straw 200 is attached to an outside surface 104 of the main body 102. Although not illustrated, the drinking straw 200 may be wrapped in an auxiliary package, e.g. a drinking straw wrap, before being attached to the outside surface 104 of the main body 102.

The liquid food package 100 further comprises a weakened area 106. The weakened area 106 is arranged on a top surface 108 of the main body 102. The weakened area 106 is in the depicted liquid food package 100 a hole in the carton-based main body 102 which laminated with thin layers of materials or a thin material layer. The laminated material or materials are typically referred to as a membrane. Examples of materials for such membrane are polymer and aluminum or other barrier materials. In other words, a membrane of packaging material is formed at the weakened area 106.

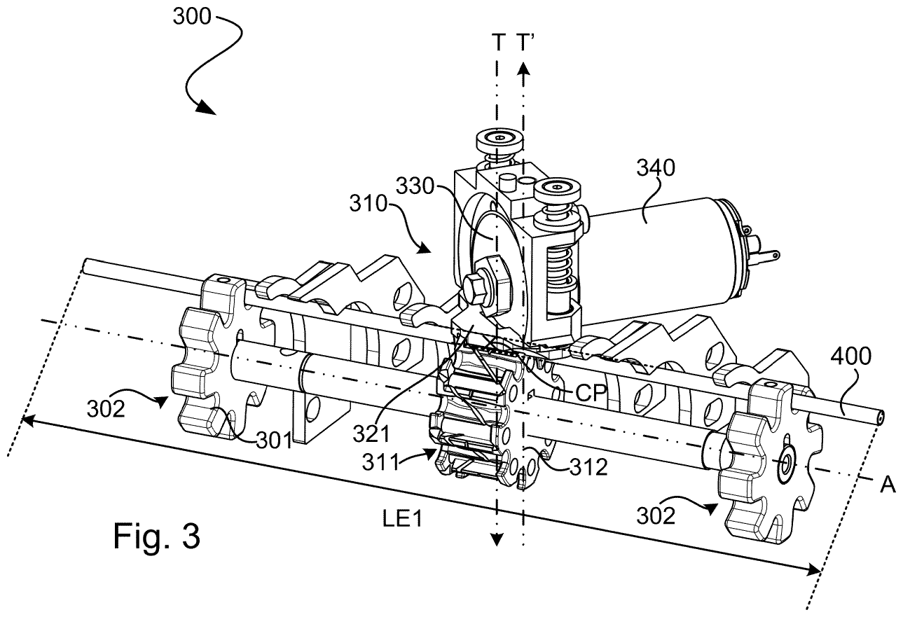

With reference to FIGS. 2a and 2b, the drinking straw 200 as introduced in FIG. 1 is illustrated by way of example. The drinking straw 200 is preferably formed from an elongated tubular body 400 which is further discussed in connection with FIGS. 3-7. The drinking straw is preferably made of paper-based material.

The drinking straw 200 comprises an elongated tubular main body portion 202. The elongated tubular main body portion 202 has a longitudinal extension LE along a longitudinal axis LA. The elongated tubular main body portion 202 comprises a pinched end portion 204 and an un-pinched end portion 206. The pinched end portion 204 forms a cut tip. The pinched end portion 204 is pinched and cut to have a sharp tip. The pinched end portion 204 is cut with a cut angle a. The depicted cut angle a is 50 degrees. Other cut angles such as a cut angle of 30-70 degrees, preferably 40-60 degrees, may be used to advantage. The cut tip is able to tear the weakened area 106 of the liquid food package 100 and break the membrane of package material. The step of pinching and cutting the pinched end portion 204 will be discussed in further detail in connection with FIGS. 3-7. The un-pinched end portion 206 may be a suction tip from which the customer may drink the drinkable food product held in the liquid food package 100. The elongated tubular main body portion 202 is preferably un-pinched between the pinched end portion 204 and un-pinched end portion 206 thereby defining an un-pinched portion 210 of the elongated tubular main body portion 202.

As best illustrated in FIG. 2b, the pinched end portion 204 defines compressed edges 204a, 204b. The compressed edges 204a, 204b are arranged opposite each other thereby forming a diamond-shaped tip. An outermost tip 208 of the cut tip, defined by the pinched end portion 204, coincides with one of the compressed edges 204a. The drinking straw 200 has a longitudinal symmetry plane. The opposite compressed edges 204a, 204b are both arranged on the longitudinal symmetry plane. As a result, the outermost tip 208 of the cut tip is also on the longitudinal symmetry plane. Additionally, as part of the shape of diamond, the straw 200 is formed having two more crease lines 205 facing each other as arranged on opposite sides of the longitudinal symmetry plane. The two more crease lines 205 act also as stiffening ribs and provides increased strength to the straw 200.

When the pinched end portion 204 takes the form of a diamond, each of the compressed edges defines a respective crease line. The respective crease line acts as stiffening ribs and provides for an increased strength of the compressed edges, the cut tip and especially for the outermost tip 208 which is for penetrating the membrane. The outermost tip 208 has a bending radius BR being 3.5% of a diameter D of the un-pinched portion 210 of the elongated tubular main body portion 202. Other bending radius such as a bending radius of 2-5% of the diameter D of the un-pinched portion 210 of the elongated tubular main body portion 202 may be used to advantage. The diameter D of the un-pinched portion 210 of the elongated tubular main body portion 202 may be 4.4-4.8 mm. However, other diameters may be used to advantage.

The pinched end portion 204 has a longitudinal extension PE being twice the diameter D of the un-pinched portion 210 of the elongated tubular main body portion 202. Other longitudinal extensions such as a longitudinal extension LE which is 50-400%, preferably 150-300%, more preferably 250-300% of the diameter D of the un-pinched portion 210 of the elongated tubular main body portion 202 may be used to advantage. It may be particularly about 266% that can be caused by the longitudinal extension from the outermost tip of 12 mm and the diameter of the un-pinched portion of the elongated tubular main body portion of 4.5 mm.

With reference to FIG. 3, a device 300 for forming two drinking straws 200 is illustrated by way of example. The device 300 comprises a mold 310 and a cutting blade 330. The mold 310 is configured to receive and pinch a central portion CP of the elongated tubular body 400. The cutting blade 330 is configured to cut the central portion CP of the elongated tubular body 400 thereby forming two similar drinking straws 200. Each of the drinking straws 200 is similar to, and comprises the same features as, the drinking straw 200 as illustrated and discussed in connection with FIGS. 2a and 2b. The elongated tubular body (400) has a longitudinal extension (LE1) seen along a main axis A.

The mold 310 comprises a plurality of lower mold sections 311 and an upper mold section 321.

Each of the lower mold sections 311 are arranged about a periphery of a roller 312. The roller 312 is rotatable about the main axis A such that each of the lower mold sections 311 is movable about the main axis A. Preferably, the roller 312 is stepwise rotatable about the main axis A. Each of the plurality of lower mold sections 311 is configured to receive the central portion CP of the elongated tubular body 400. When the roller 312 is rotated about the main axis A, each of the lower mold sections 311 are configured to transport the elongated tubular body 400 towards a pinching and cutting position PCP. Thus, each of the lower mold sections 312 are moved towards the pinching and cutting position PCP by the roller 312 being rotated about the main axis A. It should be noted that only one lower mold section 311 is positioned in the pinching and cutting position PCP at the time.

The upper mold section 321 is arranged above the pinching and cutting position PCP. The upper mold section 321 is movable in a transverse direction T, being transverse to the main axis A, towards the lower mold section 311 positioned in the pinching and cutting position PCP. The upper mold section 321 is movable in a direction T′ opposite the transverse direction T thereby away from the lower mold section 311 positioned in the pinching and cutting portion PCP.

The cutting blade 330 is arranged above the upper mold section 321 as seen in the direction T′ opposite the transverse direction T. The cutting blade 330 is movable in the transverse direction T towards the elongated tubular body 302 and cutting the central portion CP of the elongated tubular body 302 positioned in the pinching and cutting position PCP. The cutting blade 330 is movable in the direction T′ opposite the transverse direction T thereby away from the elongated tubular body 400 positioned in the pinching and cutting portion PCP.

The upper mold section 321 and the cutting blade 330 are moved in the transverse direction T and in the direction T′ opposite the transverse direction T by means of a motor unit 340.

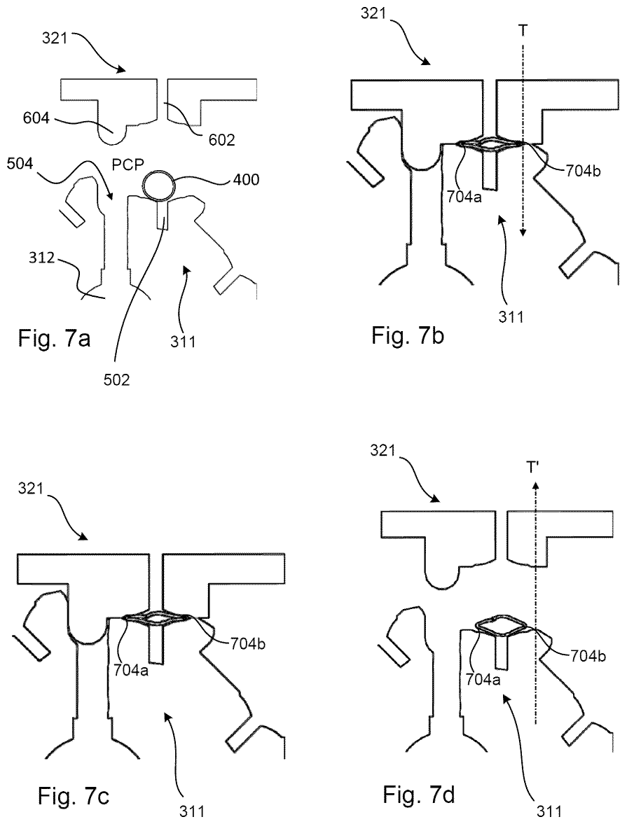

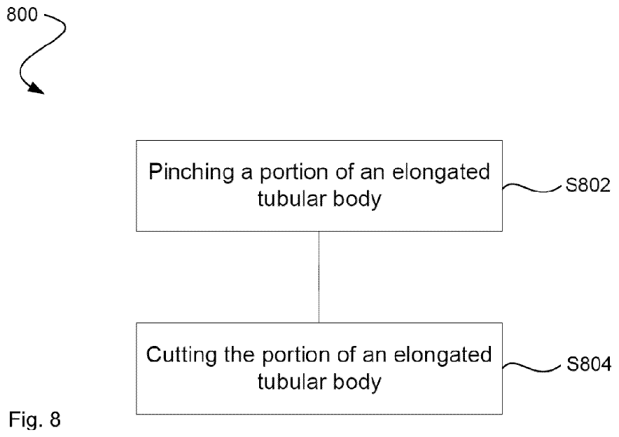

The pinching and cutting of the elongated tubular body 400 are illustrated and discussed in further detail in connection with FIGS. 7a-7d and 8.

The device 300 further comprises two support rollers 302 configured to support the elongated tubular body 400. The support rollers 302 have a plurality of support sections 301 configured to hold further portions of the elongated tubular body 400. Preferably, the number of support sections 301 are equal to the numbers of lower mold sections 311. In the depicted figure, the roller 312 comprises eight lower mold sections 311 and the support rollers 302 comprises eight support sections 301. The support roller 302 is rotatable about the main axis A such that each of the support sections 301 is movable about the main axis A. The support rollers 302 are movable with the same angular velocity as the roller 312.

It should be noted that the device 300 typically comprises other components which are not depicted and discussed in connection with these figures. The device 300 may form a part of a processing line.

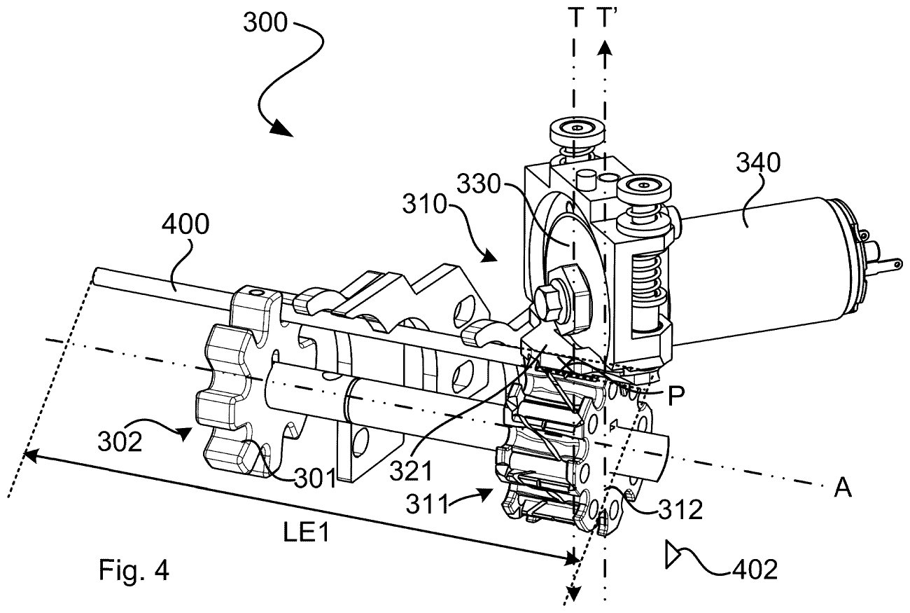

With reference to FIG. 4, a variant of the device 300 of FIG. 3 is illustrated by way of example. The variant of the device 300 is for forming one drinking straw 200 at the time. The variant of the device 300 is similar to, and comprises the same features as, the device 300 as discussed in connection with FIG. 3 except that the variant of the device 300 depicted in FIG. 4 comprises one support roller 302 instead of two support rollers 302.

The variant of the device 300 is configured to pinch and cut a portion P of the elongated tubular body 400 thereby forming the drinking straw 200 as illustrated in FIGS. 2a and 2b. The portion P is typically not the central portion CP but an end portion. When cutting the portion P, a small piece of waste material 402 having a general triangular shape is removed from the elongated tubular body 400 such that the sharp and angled pinched end portion 204 is formed.

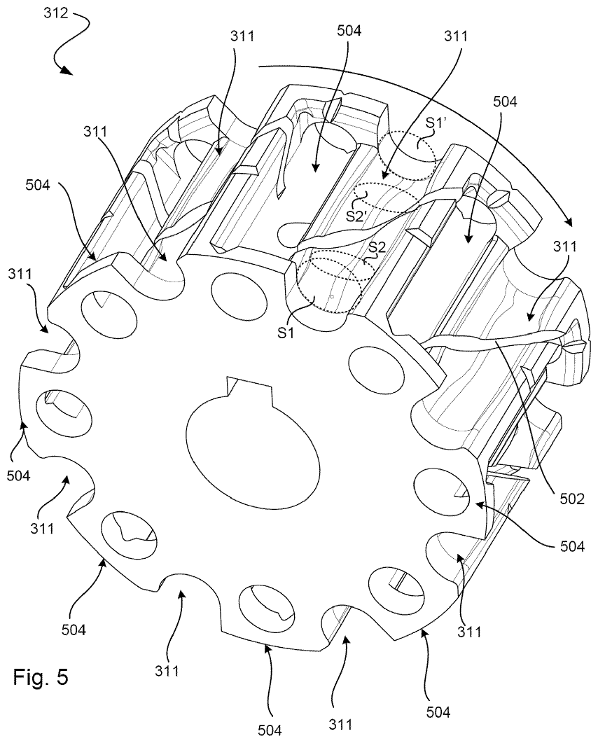

With reference to FIG. 5, the roller 312 and the plurality of lower mold section 311 are illustrated in further detail. Herein, the cutting blade receiving notch 502 of the respective lower mold section 311 is illustrated in further detail. The cutting blade receiving notch 502 has the similar angle as the cut angle a of the pinched end portion 204 as illustrated in FIG. 2.

It has above been discussed that the pinched end portion 204 has an increased degree of compression towards the outermost tip 208. This is illustrated by the shapes S1-S2 and S1′-S2′ formed by dotted lines in one of the plurality of lower mold sections 311. The shapes S2 and S2′ have reduced curvatures as compared to the shapes S1 and S1′. Hence, when elongated tubular body 400 of a drinking straw 200 is compressed by a mold including the lower mold section 311 and a corresponding upper mold section 321 a degree of compression will increase towards the cutting blade receiving notch 502. In other words, a degree of compression of the elongated tubular body 400 will decrease towards the position in which the outermost tip 408 is formed.

In addition to what have been discussed above, the roller 312 comprises eight receiving sections 504 configured to receive a protrusion 604 of the upper mold section 321 when the upper mold section 321 is moved towards the lower mold section 311 as illustrated in FIGS. 7b and 7c.

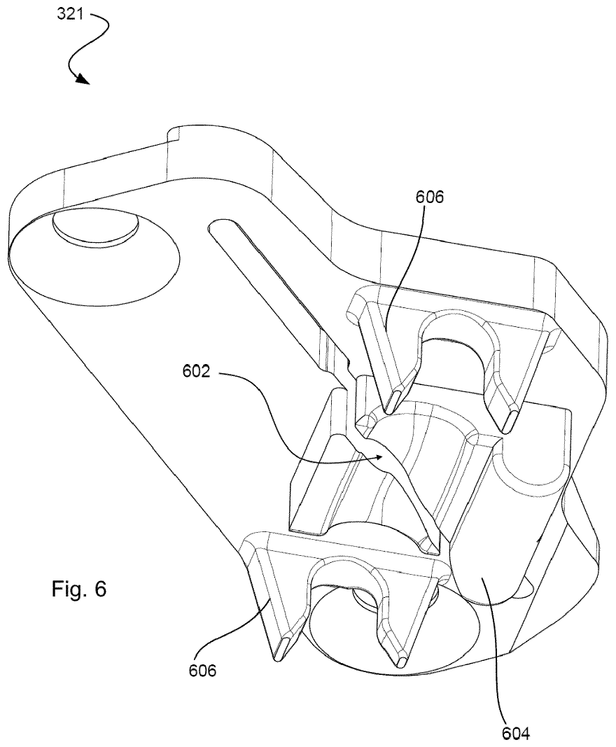

With reference to FIG. 6, the upper mold section 321 is illustrated in further detail. Herein, the cutting blade receiving notch 602 is illustrated in further detail. It should be understood that the cutting blade receiving notch 602 of the upper mold section 321 is configured to coincide with the cutting blade receiving notch 502 of the lower mold section 311 when the upper mold section 321 is moved towards the lower mold section 311 such that the cutting blade 330 may cut the elongated tubular body without impact, or with a reduced impact, on the respective mold sections 311, 321.

The upper mold section 321 further comprises the protrusion 604 configured to be received by the receiving section 504 of the respective lower mold section 311 when the upper mold section 321 is moved towards the lower mold section 311. The protrusion 604 has a stabilizing effect and holds the respective mold sections 311, 321 firmly in place when pinching the elongated tubular body 400 as described above.

The upper mold section 321 further comprises two straw controlling units 606 configured to guide the elongated tubular body 400 in a correct position when the upper mold section 321 is moved towards the lower mold section 311.

With reference to FIGS. 7a-7d, steps of pinching and cutting the elongated tubular body 400 is illustrated by way of example.

In FIG. 7a, one of the lower mold sections 311 has fed the elongated tubular body 400 to the pinching and cutting position PCP. Once, the elongated tubular body 400 is positioned in the pinching and cutting position PCP, the roller 312 stops rotating such that the elongated tubular body 400 is kept in the pinching and cutting position PCP. Further depicted in FIG. 7a, the upper mold section 321 is arranged at a distance from the lower mold section 311 and the cutting blade 330 is positioned above the upper mold section 321.

In FIG. 7b, the upper mold section 321 has been moved in the transverse direction T towards the lower mold section 311. The upper mold section 321 is pressed towards the lower mold section 311 such that the portion P of the elongated tubular body 400 is pinched thereby forming the compressed edges 704a, 704b as discussed above. In FIG. 7b, it is clearly illustrated the increased compression towards the compressed edges 704a, 704b. The cutting blade 330 is still positioned above the upper mold section 321.

In FIG. 7c, the cutting blade 330 has been moved in the transverse direction T towards and through the elongated tubular body 400 thereby cutting and forming the drinking straw 200. The upper mold section 321 and the lower mold sections 311 comprises the respective cutting blade receiving notch 502, 602 in order for the cutting blade 330 to not impact on any of the mold sections 311, 321.

In FIG. 7d, the upper mold section 321 and the cutting blade 330 have been moved in the direction T′ opposite the transverse direction T, away from the lower mold section 311. It is depicted how the compressed edges 707a, 707b of the elongated tubular body 400 are kept compressed after the upper mold section 321 has been moved. Thus, the elongated tubular body 400 is plastically deformed when being pinched between the upper and lower mold sections 321, 311. The upper mold section 321 and the cutting blade 330 may be moved in the direction T′ opposite the transverse direction T at the same time or one after the other.

Thus, the device 300 is configured to receive the elongated tubular body 400 (FIG. 7a), pinch the portion P of the elongated tubular body 400 (FIG. 7b), cut the portion P of the elongated tubular body 400 (FIG. 7c) and release the elongated tubular body 400 (FIG. 7d) in order to form the drinking straw 200.

With reference to FIG. 8, a flowchart illustrating a method 800 for forming the drinking straw 200 by way of example is shown. The method 800 comprises a first step S802 in which a portion P of the elongated tubular body 400 is pinched thereby forming the opposite compressed edges 704a, 704b.

Thereafter, in a second step S804, the pinched portion P is cut by an oblique angle in relation to the longitudinal extension LE1 of the elongated tubular body 400 between the opposite compressed edges 704a, 704b. Thereby, the drinking straw 200 as illustrated in FIGS. 2a and 2b is formed. The drinking straw 200 comprises the similar features as illustrated and discussed in FIGS. 2a and 2b.

Optionally, the second step S804 may comprise cutting the pinched portion P at a central portion CP of the elongated tubular body 400. Thereby, two drinking straw 200 are formed as illustrated and discussed in connection with FIG. 3 are formed. Each of the drinking straws 200 having the similar features as illustrated and discussed in FIGS. 2a and 2b.

Optionally, the first step S802 may comprise that the pinching of the portion P of the elongated tubular body 400 provides an increased degree of compression towards the outermost tip 208.

Even though illustrated and described in a certain order, other orders may also be used.

From the description above follows that, although various embodiments of the invention have been described and shown, the invention is not restricted thereto, but may also be embodied in other ways within the scope of the subject-matter defined in the following claims.

1. A drinking straw comprising:
at least one elongated tubular main body portion;
the elongated tubular main body portion comprising a pinched end portion, wherein the pinched end portion defines opposite compressed edges of the elongated tubular main body portion, and wherein the pinched end portion is cut with an oblique angle in relation to an longitudinal extension of the at least one elongated tubular main body portion and extending between the opposite compressed edges, thereby defining a cut tip, wherein an outermost tip of the cut tip coincides with one of the compressed edges.

2. The drinking straw according to claim 1, wherein the pinched end portion is cut with an oblique angle of 30-70 degrees, preferably 40-60 degrees, more preferably 50 degrees.

3. The drinking straw according to claim 1-, wherein a bending radius of the associated compressed edge at the outermost tip is 2-5%, preferably 3.5%, of a diameter of an un-pinched portion of the elongated tubular main body portion.

4. The drinking straw according to claim 1, wherein the pinched end portion has an increased degree of compression towards the outermost tip.

5. The drinking straw according to claim 1, wherein the pinched end portion has a longitudinal extension from the outermost tip which is 50-400%, preferably 150-300%, more preferably 250-300% of the diameter of the un-pinched portion of the elongated tubular main body portion.

6. The drinking straw according to claim 1, wherein the drinking straw is made of paper-based material.

7. A device for forming a drinking straw from an elongated tubular body, the device comprising:
a mold configured to receive and pinch a portion of the elongated tubular body, wherein the mold is configured to pinch the portion thereby forming opposite compressed edges of the elongated tubular body, and
a cutting blade configured to cut the portion with an oblique angle in relation to a longitudinal extension of the elongated tubular body between the opposite compressed edges while forming at least one cut tip at the portion of the elongated tubular body,
thereby forming the drinking straw, wherein the drinking straw has at least one elongated tubular main body portion and a pinched end portion, wherein the pinched end portion has a cut tip, wherein an outermost tip of the cut tip coincides with one of the compressed edges.

8. The device according to claim 7, wherein the elongated tubular body has a longitudinal extension being equal to a length of two drinking straws and wherein the mold is configured to receive and pinch a central portion (GP) of the elongated tubular body and the cutting blade is configured to cut the central portion (CP) of the elongated tubular body,
thereby forming two drinking straws, wherein each drinking straw has at least one elongated tubular main body portion and a pinched end portion, wherein the pinched end portion has a cut tip, wherein an outermost tip of the cut tip coincides with one of the compressed edges.

9. The device according to any one of claim 7, wherein the mold comprises:
a plurality of lower mold sections, each lower mold section being arranged about a periphery of a roller and being configured to feed the elongated tubular body to a pinching and cutting position when the roller being rotated about a main axis, and
an upper mold section being configured to be moved in a transverse direction towards one of the plurality of lower mold sections being arranged in the pinching and cutting position, wherein, when the upper mold section is moved towards the one of the plurality of lower mold sections, the upper mold section and the lower mold section pinches the portion of the elongated tubular body.

10. The device according to claim 9, wherein the upper mold section and each of the plurality of lower mold sections comprises a respective cutting blade receiving notch configured to receive the cutting blade while cutting of the portion (P) of the elongated tubular body.

11. The device according to claim 7, wherein the cutting blade is a rotating circular cutting blade.

12. A method for forming a drinking straw from an elongated tubular body, the method comprising:
pinching a portion of the elongated tubular body thereby forming opposite compressed edges; and
cutting the pinched portion at an oblique angle in relation to the longitudinal extension of the elongated tubular body between the opposite compressed edges,
thereby forming the drinking straw wherein the drinking straw has at least one elongated tubular main body portion and a pinched end portion, wherein the pinched end portion has a cut tip, wherein an outermost tip of the cut tip coincides with one of the compressed edges.

13. The method according to claim 12, wherein the step of cutting the pinched portion comprises cutting the pinched portion at a central portion of the elongated tubular body,
thereby forming two corresponding drinking straws, wherein each drinking straw has at least one elongated tubular main body portion and a pinched end portion, wherein the pinched end portion has a cut tip, wherein an outermost tip of the cut tip coincides with one of the compressed edges.

14. The method according to claim 12, wherein the step of pinching the portion of the elongated tubular body provides an increased degree of compression towards the outermost tip.

15. A liquid food package for holding a liquid food product, the liquid food package comprising:
a main body for holding the liquid food product, and a drinking straw according to claim 1 being attached to an outside surface of the main body.
